(19) United States
(12) Patent Application Publication
(10) Pub. No.: US 2006/0233691 A1
(43) Pub. Date: Oct. 19, 2006

(54) Durable catalyst for processing carbonaceous fuel, and the method of making

(76) Inventors: Thomas Henry Vanderspurt, Glastonbury, CT (US); Rhonda H. Willigan, Manchester, CT (US)

Correspondence Address: Stephen A. Schneeberger, 49 Arlington Road, West Hartford, CT, 06107, US

(21) Appl. No.: 11/091,241

(22) Filed: Mar. 28, 2005

(51) Int. Cl. C01F 17/00

(52) U.S. Cl. 423/263; 48/128

(57) ABSTRACT

A doped, nanocrystalline, ceria-containing, mixed metal oxide supports a noble metal to provide a thermally-durable catalyst for processing carbonaceous fuels, particularly for the water gas shift reactions. The mixed metal oxide includes Zr and/or Hf and is normally susceptible to oxide ion vacancy ordering at elevated temperature reducing conditions. A dopant is selected to inhibit such oxide ion vacancy ordering. The dopant is preferably selected from the group consisting of W, Mo, Ta, and Nb, most preferably W, for providing a thermally-durable catalyst at operating temperatures exceeding 400° C. The noble metal is preferably Pt and/or Re. The doped ceria-containing mixed metal oxide is prepared from 2 or 3 aqueous solutions variously containing ceria, Zr and/or Hf, the dopant, and urea. The solutions are heated to below boiling, combined in a particular sequence and manner, and brought to boiling to crystallize and precipitate the doped ceria-containing mixed metal oxide.

### TECHNICAL FIELD

This invention relates to catalysts, and more particularly to catalysts for processing carbonaceous fuel and the process for making such catalysts. More particularly still, the invention relates to such catalysts being mixed metal oxides, and particularly, ceria-containing mixed metal oxides. Even more particularly, the invention relates to the provision of such catalysts having thermal durability.

### BACKGROUND ART

Various metal oxides have found use in chemically reactive systems as catalysts, supports for catalysts, gettering agents and the like. In those usages, their chemical characteristics and morphologies may be important, as well as their ease and economy of manufacture. One area of usage that is of particular interest is in fuel processing systems for carbonaceous fuels. Carbonaceous fuels are those containing at least 0.9 hydrogen per unit of carbon, and may include hetero atoms such as O, N, and/or S. Typically, such fuels are hydrocarbons or alcohols. Fuel processing systems catalytically convert carbonaceous fuels into hydrogen-rich fuel streams by reaction with water and oxygen. The conversion of carbon monoxide and water into carbon dioxide and hydrogen through the water gas shift (WGS) reaction is an essential step in these systems. Preferential oxidation (PROX) of the WGS product using such catalysts may also be part of the process, as in providing hydrogen fuel for a fuel cell. Industrially, iron-chrome catalysts, often promoted, are used as high temperature shift catalysts, and copper-zinc oxide catalysts, often containing alumina and other products, are effective low temperature shift catalysts. These catalysts are less desirable for use in fuel processing systems because they require careful reductive activation and can be irreversibly damaged by air after activation.

Recent studies of automotive exhaust gas “three-way” catalysts (TWC) have described the effectiveness of a component of such catalysts, that being noble metal on cerium oxide, or “ceria” (CeO₂), for the water gas shift reaction because of its particular oxygen storing capacity (OSC). Indeed, the ceria may even act as a “co-catalyst” with the noble metal loading in that it, under reducing conditions, acts in concert with the noble metal, providing oxygen from the CeO₂ lattice to the noble metal surface to oxidize carbon monoxide and/or hydrocarbons adsorbed and activated on the surface. This is described in greater detail in an article entitled “Studies of the water-gas-shift reaction on ceria-supported Pt, Pd, and Rh: implications for oxygen storage properties”, by T. Bunluesin, et al, in Applied Catalysis B: Environmental 15 (1998) at pages 107-114. Another, possibly parallel or possibly alternative, mechanism for the water gas shift reaction over a CeO₂ support lattice is described in an article entitled “Reactant-Promoted Reaction Mechanism for Water-Gas Shift Reaction on Rh-Doped CeO₂” by T. Shido, et al, in Journal of Catalysis, 141, (1993) at pages 71-81, in which formate is identified as a WGS intermediate produced from CO and surface OH groups.

In many cases the ceria component of these catalysts is not pure ceria, but cerium oxide mixed with zirconium oxide and optionally, other oxides such as rare earth oxides. It has been determined that the reduction/oxidation (redox) behavior of the cerium oxide is enhanced by the presence of ZrO₂ and/or selected dopants. Robustness at high temperatures is an essential property of TWC's, and thus, such catalysts do not typically have either sustainable high surface areas, i.e., greater than 100 m²/g, or high metal dispersion (very small metal crystallites), even though such features are generally recognized as desirable in other, lower temperature, catalytic applications.

For mixed-metal oxides that are to be used as co-catalysts, referred to herein as “supports” and which comprise cerium oxide and zirconium and/or hafnium oxide, it is generally desirable that they possess a cubic structure. The cubic structure is generally associated with greater oxygen mobility, and therefore greater catalytic activity. Moreover, the zirconium and/or hafnium provide thermal stability, and thus contribute to the thermal stability and life of a catalyst. Yashima et al., in an article entitled “Diffusionless Tetragonal-Cubic Transformation Temperature in Zirconia Solid Solution” in Journal of American Ceramic Society, 76 [11], 1993, pages 2865-2868, have shown that cubic ceria undergoes a phase transition to tetragonal when doping levels of zirconia are at or above 20 atomic percent. They suggest that above 20 percent zirconia, the oxygen anion lattice distorts into a tetragonal phase, while the cerium and zirconium cations remain in a cubic lattice structure, creating a non-cubic, metastable, pseudo-tetragonal phase lattice. Traditionally, powder X-ray diffraction (PXRD) is used to identify the structure and symmetry of such phases. However, in the case of ceria-zirconia oxides with very small crystallite sizes (i.e., less than 3 nm), the PXRD signal exhibits broadened peaks. Additionally, the signal produced by the oxygen atoms, which is a function of atomic weight, is drowned out by the intense signal produced by the cerium and zirconium cations. Thus any tetragonal distortion, caused by the oxygen atoms shifting in the lattice, goes unnoticed in a PXRD pattern and the resulting pattern appears cubic. In such cases, Raman spectroscopy and X-ray absorption fine structure (EXAFS) can be employed to observe such phase transitions. Yashima et al. have published Raman spectroscopy and EXAFS studies in support of the position taken above. Vlaic et al., in an article entitled “Relationship between the Zirconia-Promoted Reduction in the Rh-Loaded Ce_{0.5}Zr_{0.5}O₂ Mixed Oxide and the Zr—O Local Structure” in Journal of Catalysis, 168, (1997) pages 386-392, have shown similar results for a phase transition at 50% zirconia, as determined by Raman spectroscopy and EXAFS.

Ceria-containing mixed metal oxides having relatively large surface areas per unit weight may be particularly well suited in various catalytic applications, as might be typified by, but not limited to, the WGS reaction. In that general regard, it is deemed desirable that the mixed oxide material be comprised of small crystallites agglomerated to form porous particles having relatively large surface areas per unit weight as a result of significant pore diameters and pore volumes. Large pore diameters facilitate mass transfer during catalytic reactions, by minimizing mass transfer resistance. On the other hand, excessive pore volumes may act to minimize the amount of effective surface area in a given reactor volume, for a given final form of catalyst, thereby limiting the catalytic action in a given reactor volume. Thus, the ratio of pore volume to the structural mass, as well as crystallite size and pore diameters, can be optimized within a range. In this regard then, the particular morphology of the ceria-containing mixed-metal oxide material becomes important for efficient operation of the material as a catalyst or getter in particular reactions and/or under particular operating conditions and geometries.

Certain homogeneous ceria-containing mixed-metal oxides possessing these general characteristics are disclosed in U.S. Patent Application Publication No. 2003/0235526 A1 by Vanderspurt et al, filed as U.S. Ser. No. 10/402,808 on Mar. 28, 2003 and published Dec. 25, 2003, and assigned to the assignee of the present application. That application is incorporated herein by reference and will hereinafter be referred to as the “'808 application”, and discloses a homogeneous ceria-containing mixed-metal oxide, useful as a catalyst support, a co-catalyst and/or a getter, having a relatively large surface area per weight, typically exceeding 150 m²/g based on an oxide with a skeletal density of about 6.6 g/cm³, a structure of nanocrystallites having small diameters, typically less than 5 nm, and, when aggregated, including pores larger than the nanocrystallites and having diameters in the range of 4 to about 9 nm. The ratio of pore volumes, VP, to skeletal structure volumes, Vs, is typically less than about 2.5, and the surface area per unit volume of the oxide material is greater than 320 m²/cm³, for low internal mass transfer resistance and large effective surface area for reaction activity. The mixed metal oxide is ceria-containing, includes Zr and/or Hf, and is made by a unique co-precipitation process. As is well known in the art, catalysts or catalyst support oxides are typically calcined at temperatures above the use temperature to minimize the crystallite growth and subsequent loss of surface area and activity during use. Higher calcining temperature typically lead to larger crystallites.

A highly dispersed catalyst metal or mixture of metals, typically a noble metal such as Pt, may be loaded on to the mixed metal oxide support from a catalyst metal-containing solution following a selected acid surface treatment of the oxide support. The small crystallite size, less than 6 nm and preferably less than 5 nm, is also key to retaining a cubic structure, even for compositions with less than 80% cerium which, as larger crystallites, would have a tetragonal or other structure. It is believed that retaining a cubic structure enhances catalytic performance. Rhenium may be loaded on to the mixed-metal oxide support to increase the activity of the catalyst. The metal-loaded mixed-metal oxide catalyst is applied particularly in water gas shift reactions as associated with fuel processing systems, as for fuel cells.

A target, or standard, of durability often used for such supported catalysts in water gas shift reactions is their ability/inability to maintain an effective activity for a period of at least 40,000 hours. Specifically it is not unusual for catalysts to demonstrate a drop in activity during the first hours of operation, and the most active sites on the heterogeneous catalyst are typically the most unstable. The most convenient time for benchmarking the fresh or initial useful activity for reactor/catalyst design purposes depends on the sum of the effects of the various deactivation mechanisms. An important mechanism in the absence of coking, and in the absence of site poisoning because of feed impurities, is the mobility of the active metal phase and the agglomeration of the very small <0.5 nm metal clusters into crystallites >1 nm, and often >2 nm. For noble metals in the absence of active hetero-atoms, (halogens, chalcogenides etc.) where the metal agglomeration is dominated by pseudo-liquid drop random surface motion this is usually a thermal phenomenon, and on a properly calcined substrate, the deactivation rate decreases with time as the smaller clusters disappear. This usually becomes significant as the temperature exceeds about ⅓ the absolute temperature melting point, or for Pt, about 680° K or 408° C. The addition of a higher melting point alloying element that does not form a volatile oxide, carbonyl etc. under the conditions of use like Rh, Ir, or Re can increase the thermal stability. It is not unusual in the art to predict activity behavior at extended intervals after the initial line out period by plotting activity versus the log of time. When this method is used with the log₁₀ of hours, a convenient initial activity point is the apparent activity at 100 hours. Then for design purposes, the time where the projected activity decreases to 50% of this initial, 100 hr, lined out activity is the projected useful life of the catalyst, at least in the absence of poisons. Alternatively, the activity at a given time can be expressed as a percentage of the initial, lined out activity.

Platinum on cerium-zirconium oxide generally is a good low temperature (<310° C.) water gas shift catalyst with projected stability sufficient for 40,000 hours of operation. The ceria-containing mixed-metal oxide catalysts formed in accordance with the aforementioned '808 application afford a significant improvement with respect to providing the desirable properties of relative stability, high surface areas, relatively small crystallites, and pore volumes sized to optimally balance the reduction of mass transfer resistance with the provision of sufficiently effective surface areas in a given reactor volume, particularly in operating temperatures below about 310-360° C. On the other hand, their stability or durability is adversely impacted as the operating temperatures increase toward 370° C. and beyond, such that they may not have durability to achieve effective conversion of carbon monoxide for 40,000 hours if the operating temperatures are 360° C. and above, as required in some preferred operating environments. Typically, these high-temperature, highly-reducing environments are found in either the 1^{st} stage water gas shift reactor, or in a high temperature >360° C., preferably about 400° C., water gas shift reactor with a gas selective membrane to remove one of the products, usually hydrogen. Accordingly, they would be viewed as deactivating too rapidly for practical use under those conditions.

As is well known in the art, some researchers have postulated that this “high temperature” deactivation of the supported catalyst is due to oxide grain growth and consequent loss of surface area, whereas others have postulated that it is due to active metal crystallite growth and the consequent loss of active sites.

Accordingly, what is needed is a catalyst support and/or a supported catalyst having many of the desirable morphological properties of the homogeneous, ceria-containing mixed-metal oxides described in the aforementioned '808 application, yet which also possess enhanced durability at relatively higher temperatures under reducing conditions.

Also needed is a process for providing a catalyst support and/or supported catalyst having the desired properties.

### SUMMARY OF INVENTION

An investigation of the activity of the aforementioned ceria-containing mixed-metal oxide catalysts formed in accordance with the aforementioned Vanderspurt et al published '808 patent application was conducted under conditions of different temperatures, to note both the amount of degradation in activity as a function of increased temperatures and to also note any significant changes in morphology. It was noted that although significant degradation in activity occurred for operation in temperatures exceeding about 310° C., the morphological changes appeared to be relatively minor. There was but relatively little fundamental crystallite size growth, e.g., from 3.22 nm to 3.63 nm, for the Ce_{0.58}Zr_{0.42}O₂, and no significant decline in surface area. Moreover, despite a 2 wt % loading of Pt, there was no evidence of Pt crystallites, thus suggesting that Pt agglomeration was not a significant factor.

The decline in activity was attributed by the inventors primarily to a loss of low temperature reducibility. Significantly, it was then further hypothesized that the primary cause for the high temperature deactivation is the loss of one of the pathways of the complex water gas shift mechanistic network. In that regard, it is believed that under high temperature, high CO concentration feed over the cerium-zirconium (and/or hafnium) oxide, a large fraction of the Ce ions get reduced to the Ce⁺³ state from the Ce⁺⁴ state, but the lattice structure retains its essential cubic fluorite structure. Initially, the presence of a high proportion of Ce⁺³ ions keeps the number of oxide ion vacancies high and maintains sufficient oxide ion conductivity that fosters the type of water gas shift mechanism described in the aforementioned Bunluesin, et al article. That mechanism may operate in parallel with a formate-type process such as described in the aforementioned Shido, et al article. It is the Bunluesin type mechanism that, in effect, allows oxide ions to attack CO molecules chemisorbed on the noble metal.

It is further believed that prolonged high temperature operation under highly reducing conditions produced by the combination of CO and hydrogen in typical water gas shift feed gas, often referred to as reformate, where there is a high fraction of the Ce⁺³ state, causes the cerium-zirconium, cerium-hafnium, or cerium-hafnium-zirconium oxide crystallite, even if nano-sized, to adopt a modified version of the cubic type, Ln₂O₃ lanthanide oxide structure described briefly at page 19 in “A Lanthanide Lanthology; Part II, M-Z” by B. T. Kilbourn (1994). In the “normal” cubic cerium(IV)-zirconium(IV), cerium (IV)-hafnium(IV), or cerium(IV)-hafnium(IV)-zirconium(IV) oxide structure, each +4 cation is in the center of a cube of oxide ions. In the limit where all cations can become +3 ions, and if the cation size is in the correct range, that is in the size range of Ce⁺³ to Lu⁺³, the cations remain in the center of a cube, but a cube in which two of the eight cubic oxide sites are vacant. These vacant sites can thus form planes of vacancies as occurs in neodymium oxide. When the oxide ion vacancies order, the energy equivalence of oxide ion sites is removed and the activation energy required for oxide ion mobility is increased, such that the oxide ion conductivity decreases, or drops. This decrease in oxide mobility decreases or eliminates the type of water gas shift mechanism described in the aforementioned Bunluesin, et al article. It is postulated that in the case of cubic Ce₍₁₋ₓ₎ MₓO₂ mixed metal oxide nano-crystals where M is at least Zr, Hf, or a mixture thereof, this oxide vacancy ordering or a phenomenon similar to it, can occur under high temperature reducing conditions. As this vacancy ordering phenomenon occurs, the resulting decline in oxide ion conductivity results in a decline in WGS activity.

Against this hypothesized basis for the decline in WGS activity of the ceria-containing, mixed-metal oxide under high temperature operation under highly reducing conditions, the invention proposes to mitigate the problem through the addition of one or more dopants having appropriately sized cations with the proper range of accessible oxidation states that will disrupt this oxide ion vacancy ordering, and thus preserve the overall catalyst activity. It has been found that a group of metal ion constituents having the desired characteristics for disrupting the oxide vacancy ordering consists of tungsten (W), niobium (Nb), tantalum (Ta), molybdenum (Mo), uranium (Ur) and thorium (Th). Because Ur and Th are environmentally objectionable, the group is practically limited to W, Nb, Ta, and Mo. Of that group, W has been found to be particularly effective as a dopant in attaining the durability of the metal oxide as a WGS catalyst under elevated operating temperatures, though combinations of W with Nb, Ta, and/or Mo are also believed to effective. While the literature on cerium oxide discusses at length rare-earth dopants and alkaline earth dopants, there has been little or no focus on these group 5 and group 6 elements. While W is perhaps the preferred dopant, the optimal choice of dopant, or dopants, and dopant concentration is a complex function of the projected catalyst operating environment, especially with respect to the partial pressures of the gases, H₂O, CO, H₂ and CO₂ expected and the temperature range the catalyst is expected to encounter. The effective range of tungsten, provided it is incorporated as a dopant in the crystallites of the ceria-containing, zirconium/hafnium-mixed metal oxide and expressed as atomic fraction of cations, is between about 0.05 and 0.15, and is preferably between about 0.07 and 0.12, and is most preferably between 0.09 and 0.11. The most preferable amount or quantity of these oxide ion ordering disruptors is a function of and determined by, the absolute cation fraction of Ce, the Zr/Hf ratio, and the operating conditions including temperature and the feed gas composition. When the oxide atomic composition is expressed as Ce_{[1-(x+y)]}MₓDp_{y}O₂, the sum of x+y can vary from about 0.35 to 0.7 but y is typically in the range of 0.05 to 0.15. M is Zr, Hf or a mixture of both. Hf is preferred, but because of cost and other considerations Zr is acceptable. Dp is one or more of the above-mentioned dopants. The inclusion of one or more of the above-mentioned dopants has been shown to significantly slow the loss of activity, such that the effective life of the WGS catalyst is relatively extended, even under conditions of increased operating temperatures that exceed 310-350° C. and may be in the range of 400-425° C. or above.

Accordingly, the present invention relates to a homogeneous, nanocrystalline, mixed metal oxide of cerium and at least a first other metal constituent selected from a first group consisting of Zr and Hf and normally being susceptible to oxide ion vacancy ordering and further including at least a second other metal ion, or for brevity, simply “metal”, constituent selected to inhibit oxide ion vacancy ordering by its chemical nature with respect to ionic size, electric orbital occupancy and orientation in the oxide lattice under operating conditions. The mixed metal oxide has an average crystallite size less than 6 nm, preferably less than 4 nm, and is agglomerated to form a skeletal structure with pores, the average pore diameters being in the range between about 4 nm and 9 nm, preferably between 4.5 nm and 6.5 nm, and normally being greater than the average crystallite size, and wherein the surface area of the skeletal structure per volume of the material of the structure is greater than about 240 m²/cm³. The mixed metal oxide of the invention finds utility as a catalyst in processing carbonaceous fuels, including reformation reactions, partial oxidation, and with particular utility as a catalyst in water gas shift reactions.

The second other metal ion constituent of the mixed metal oxide capable of preventing oxide ion vacancy ordering is selected from a second group consisting of Nb, Ta, Mo, W, Th and U, with a metal from the group consisting of Nb, Ta, Mo, and W being generally preferred, and W being the most preferred. In embodiments that include W to prevent oxide ion vacancy ordering, the quantity of W is expressed as y in the expression Ce_{[1-(x+y)]}MₓW_{y}O₂—Where the quantity of x+y is between 0.35 [Ce_{0.65}] and 0.7 [Ce_{0.3}], and when x is between 0.2 and 0.6, then y is between about 0.05 and 0.15, and is preferably between about 0.07 and 0.12, and is most preferably between 0.09 and 0.11.

The invention relates also to the process for making mixed metal oxides having the constituents and properties described above, and further, to the use of such mixed metal oxides as catalysts for processing carbonaceous fuels at elevated temperatures, as in water gas shift reactions occurring in temperatures typically exceeding about 350° C. and up to about 425° C. More particularly, the invention relates to the process for making such mixed metal oxides having the constituents of Ce, Zr and/or Hf, and W and/or Mo, as well as the process for making mixed metal oxides having the constituents of Ce, Zr and/or Hf, and Ta and/or Nb. The process for making the ceria-containing mixed metal oxide having the oxide ion vacancy-ordering inhibitor is generally similar to that described in the '808 application, with some modification of the manner in which the constituents are initially combined prior to precipitation. The process generally includes the steps of 1) dissolving salts of the cerium and the zirconium and/or hafnium to form a metal salt solution; 2) creating an aqueous solution containing the oxide ion vacancy-ordering inhibitor (eg., Mo, Nb, Ta, and/or W); 3) creating an aqueous solution containing urea, either as a separate solution or in combination with the cerium-containing solution; 4) heating the respective solutions to the appropriate temperature, typically 70° C. or above for that solution; 5) combining the solutions, which for the W and/or Mo oxide ion vacancy-ordering inhibitor comprises 5A) carefully (ie, slowly) combining the aqueous solution containing the oxide ion vacancy-ordering inhibitor with the cerium-containing solution, and for the Ta and/or Nb oxide ion vacancy-ordering inhibitor comprises 5B) initially combining the cerium-containing solution slowly with the oxide ion vacancy-ordering inhibitor solution to avoid turbidity and subsequently adding quickly the separate urea solution; 6) heating the combined solutions to boiling to coprecipitate homogeneously a nano-crystalline mixed-oxide of the cerium, the zirconium and/or hafnium, and the one or more other constituent(s) that at least include the oxide ion vacancy-ordering inhibitor; 7) optionally maturing, if and when beneficial, the coprecipitate in accordance with a thermal schedule; 8) replacing water in the solution with a water miscible, low surface-tension solvent, such as dried 2-propanol; 9) drying the coprecipitate and solvent to remove substantially all of the solvent; and 10) calcining the dried coprecipitate at an effective temperature, typically moderate in the range of 250° C. to 600° C., for an interval sufficient to remove adsorbed species and strengthen the structure against premature aging.

More specifically, the process that incorporates W and/or Mo generally includes the steps of 1) dissolving salts of the cerium and the zirconium and/or hafnium to form a metal salt solution; 2) creating an aqueous solution containing the oxide ion vacancy-ordering inhibitor (eg., Mo, and/or W); 3) creating an aqueous solution containing urea, either as a separate solution or in combination with the cerium-containing solution; 4) heating the respective solutions to about 92° C., near boiling; 5) combining the cerium and the zirconium and/or hafnium and the aqueous solution containing urea if not already combined, then, just at the point of precipitation where the pH of the combine solution changes rapidly from acidic to basic, carefully with adequate mixing, adding the aqueous solution containing the oxide ion vacancy-ordering inhibitor tungsten and/or molybdenum; 6) heating the combined solutions to boiling to crystallize and coprecipitate homogeneously a mixed-oxide of the cerium, the zirconium and/or hafnium, and the one or more other constituent(s) that at least include the oxide ion vacancy-ordering inhibitor; 7) optionally maturing, if and when beneficial, the coprecipitate in accordance with a thermal schedule; 8) replacing water in the solution with a water miscible, low surface-tension solvent, such as dried 2-propanol; 9) drying the coprecipitate and solvent to remove substantially all of the solvent, optionally under vacuum; and 10) calcining the dried coprecipitate at an effective temperature, typically moderate in the range of 250° C. to 600° C., for an interval sufficient to remove adsorbed species and strengthen the structure against premature aging.

Alternatively, the process that incorporates Nb and/or Ta generally includes the steps of 1) dissolving salts of the cerium and the zirconium and/or hafnium to form a metal salt solution; 2) creating an aqueous solution containing the oxide ion vacancy-ordering inhibitor (eg. Nb and/or Ta); 3) creating a separate aqueous solution containing urea; 4) heating, with constant stirring, the respective cerium, zirconium and/or hafnium and the oxide ion vacancy-ordering inhibitor (eg. Nb and/or Ta) solutions to about 70° C. and the urea solution to, or nearly to, boiling; 5) adding the hot, 70° C., solution of Nb and/or Ta slowly to the solution of cerium, zirconium and/or hafnium to minimize the turbidity of the combined Ce, Zr and/or Hf, and Nb and/or Ta solution; 6) adding the hot, at least 92° C., preferably just boiling, solution of urea quickly to the metal solution; 7) raising the temperature of the combined solution to 100° C. to crystallize/coprecipitate the oxide from solution; 8) after oxide crystallization/precipitation is observed, optionally maturing, if and when beneficial, the coprecipitate in accordance with a thermal schedule; 9) washing the coprecipitated nano-crystalline oxide with water; 10) replacing water in the solution with a water miscible, low surface-tension solvent, such as dried 2-propanol; 11) drying the coprecipitate and solvent to remove substantially all of the solvent, optionally under vacuum; and 12) calcining the dried coprecipitate at an effective temperature, typically moderate in the range of 250° C. to 600° C., for an interval sufficient to remove adsorbed species and strengthen the structure against premature aging.

The foregoing features and advantages of the present invention will become more apparent in light of the following detailed description of exemplary embodiments thereof as illustrated in the accompanying drawings.

### BRIEF DESCRIPTION OF DRAWINGS

FIG. 1 is a simplified schematic block diagram of a system for processing carbonaceous fuels and employing a durable catalyst in accordance with the invention;

FIG. 2 is a graphical depiction of the CO-conversion durability of a typical ceria-containing, mixed metal oxide and noble metal water gas shift catalyst operated at low temperatures;

FIG. 3 is a graphical depiction of the relatively degraded CO-conversion durability of the typical ceria-containing, mixed metal oxide and noble metal water gas shift catalyst of FIG. 2 when operated at elevated temperatures; and

FIG. 4 is a graphical comparison of the CO-conversion durabilities, at elevated temperatures, of a typical ceria-containing, mixed metal oxide and noble metal water gas shift catalyst as in FIGS. 2 and 3, versus the WGS catalyst of the invention that contains a durability-enhancing dopant.

### BEST MODE FOR CARRYING OUT THE INVENTION

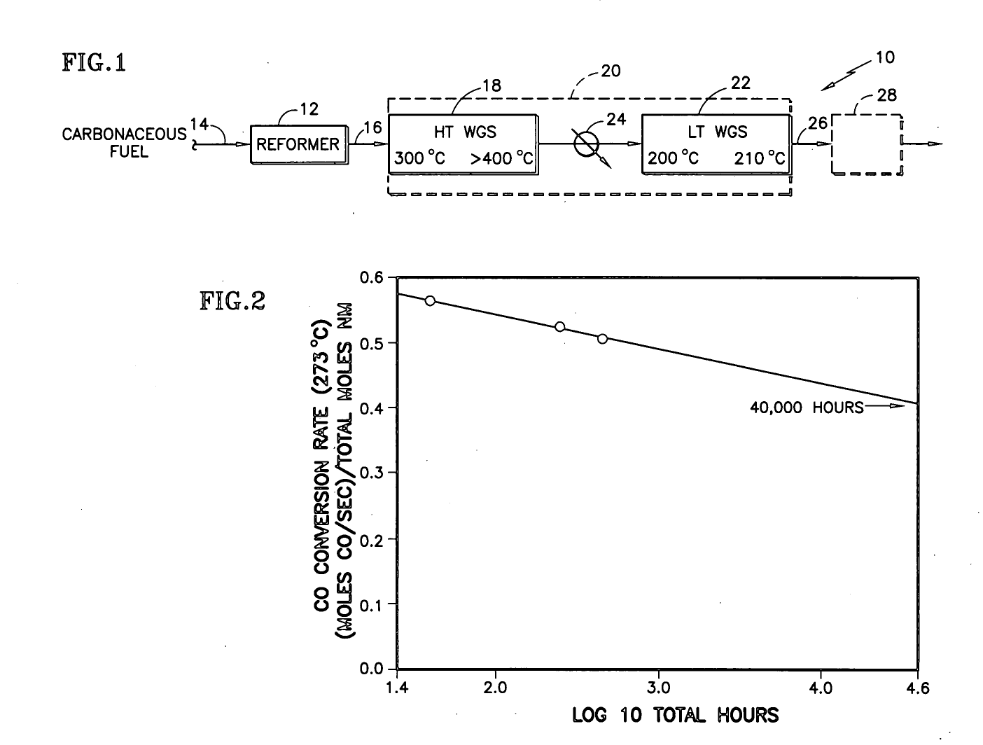

Referring first to FIG. 1, there is illustrated a simplified schematic block diagram of a fuel processing system (FPS) 10 for processing carbonaceous fuels and employing a durable catalyst in accordance with the invention. The FPS 10 is typically suited for the production of a hydrogen-rich fuel stream, as for use in a fuel cell or the like. The FPS 10 typically includes a reformer 12 that converts (or reforms) a carbonaceous fuel feedstock 14, in the presence of steam and air, to a reformate mixture 16 of H₂, CO, CO₂, H₂0, (and N₂). Thereafter, the reformate 16 is supplied to a high-temperature water gas shift reactor (HT WGS) 18, which typically includes a vaporizer and a catalytic reactor. The HT WGS 18 is the first stage of a two-stage WGS section 20 shown in broken line, the second stage being a low-temperature water gas shift reactor (LT WGS) 22. Requisite supplies and control of air, steam and/or water to the relevant sections of the FPS 10, though not shown, are implied and well understood.

The HT WGS 18 reduces the CO level (i.e. concentration) and enriches the hydrogen level by supplying additional steam or moisture and reacting it with the reformate 16, according to the reaction (and heat of reaction):
CO+H₂O<=>CO₂+H₂ ΔH₁=−41 kJ/mole H₂ (1)
This reaction is exothermic (in the forward direction) and equilibrium-limited, with lower temperatures favoring higher CO conversions. However, the reaction rate of the HT WGS catalyst increases exponentially with temperature. Thus, the existing practice that optimizes thermodynamics and kinetics of existing HT WGS catalysts is to also use the second, or low-temperature, water gas shift reactor (LT WGS) 22. The LT WGS 22 typically includes a cooler (heat exchanger) 24 preceding the reactor. The vaporizer 22 serves as a cooling device and also provides additional steam for the reactor 24.

The reformate 16 from the reformer 12 may typically have CO levels of 100,000 ppmv (10%), whereas the HT WGS 18 is intended to reduce the CO level to about 20,000 ppmv (2%) and the LT WGS 22 further reduces it to about 6,000 ppmv (0.6%). The ultimate use of the hydrogen-rich reformate stream 26 issuing from the LT WGS 22 will determine whether further CO removal is required. In the instance where reformate stream 26 is intended to supply H₂ to a fuel cell, it will usually be necessary to reduce the CO level further, as by the optional preferential oxidizer 28 shown in broken line.

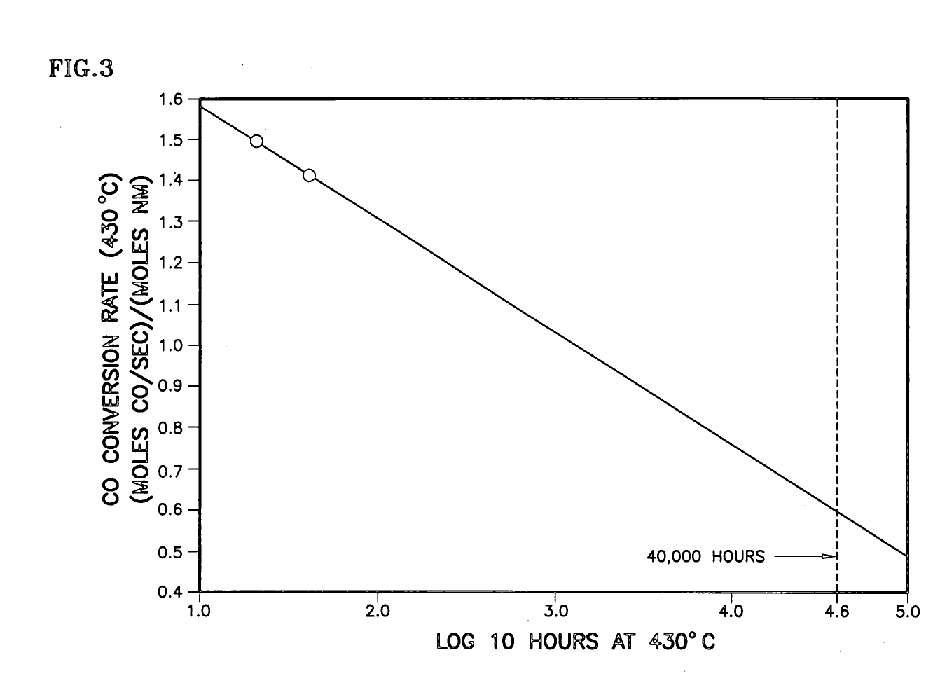

The catalyst in the LT WGS reactor 24 has previously been Cu/ZnO or the like, and more recently may be a noble metal on a ceria-containing mixed metal oxide support of the type described in the aforementioned '808 application incorporated herein by reference. Such latter catalysts have high activity and perform well at the relatively lower operating temperatures (200-300° C.) experienced in the LT WGS 22, but have not had the requisite durability for use in higher temperature water gas shift reactors, such as HT WGS 18, where operating temperatures may typically range from 300° C. at entry to about 450° C. at discharge. A typical HT-WGS catalyst is a promoted iron-chrome catalyst, such as KATALCO 71-Series HTS catalysts. These capabilities and limitations of the noble metal on ceria-containing mixed metal oxide support of the type described in the aforementioned '808 application are depicted in FIGS. 2 and 3, in which measurements of CO conversion activity during the first 50-200 hours of operation are extrapolated to 40,000 hours.

Referring first to FIG. 2, the durability of that catalyst is depicted under operating temperatures of approximately 273° C. The y-axis is rate or catalyst activity expressed as [(Moles CO/Sec)/(Total Moles Noble Metal)]. As discussed earlier, it is desired that the catalyst have, after 40,000 hours of operation, an activity level that is at least 65% of its activity level at 100 hours. Here it is seen that the activity level, in terms of rate of conversion of CO per unit of noble metal catalyst, is about 0.55 at 100 hours, and is about 0.4 at 40,000 hours. Thus, the activity level at 40,000 hours is about 73% of the 100-hour activity level, and is representative of good durability under those operating conditions.

Referring next to FIG. 3, the durability of that same catalyst is evaluated at higher operating temperatures of 430° C. Here it is seen that the rate of decline in activity is significantly increased, with an activity rate of 1.3 at 100 hours being projected to be at a level of 0.6 at 40,000 hours. This represents a decline to about the 46% level, thus adversely affecting its value, at least from the standpoint of durability.

It is generally held from these evaluations, that the durability of the catalyst described in the '808 application should be acceptable for operating temperature conditions that are less than about 330-350° C., but may generally have unacceptable durability when the operating temperatures exceed those levels, and particularly in the range of 400° C. to 425° C., or above, as seen near the discharge zone of the HT WGS reactor 18. As will be discussed below, the mixed metal oxide support of the present invention provides the increased durability desired for long-term operation at temperatures certainly exceeding 350° C. and up to about 425° C., or above.

As postulated in the Summary of the Invention above, it is believed that prolonged high temperature operation under highly reducing conditions produced by the combination of CO and hydrogen in typical water gas shift feed gas where there is a high fraction of the Ce⁺³ state, causes the cerium-zirconium, cerium-hafnium, or cerium-hafnium-zirconium oxide crystallite, even if nano-sized, to adopt a modified version of the cubic type, Ln₂O₃ lanthanide oxide structure. In the limit where all cations can become +3 ions, and if the cation size is in the correct range, that is in the size range of Ce⁺³ to Lu⁺³, the cations remain in the center of a cube, but a cube in which two of the eight cubic oxide sites are vacant. These vacant sites can thus form planes of vacancies as occurs in neodymium oxide. When the oxide ion vacancies order, the energy equivalence of oxide ion sites is removed and the activation energy required for oxide ion mobility is increased, such that the oxide ion conductivity decreases, or drops. This decrease in oxide mobility decreases or eliminates the type of water gas shift mechanism described in the earlier-mentioned Bunluesin, et al article. It is postulated that in the case of cubic Ce₍₁₋ₓ₎MₓO₂ mixed metal oxide nano-crystals where M is at least Zr, Hf, or a mixture thereof, this oxide vacancy ordering or a phenomenon similar to it, can occur under high temperature reducing conditions. It is possible that one nano-crystallite at a time reaches the ordered vacancy state and suffers a severe enough drop in oxide ion conductivity that its WGS activity declines also.

To inhibit or reduce the decline in WGS activity of the ceria-containing, mixed-metal oxide under high temperature operation under highly reducing conditions, the invention adds one or more dopants having appropriately sized cations with the proper range of accessible oxidation states that will disrupt this oxide ion vacancy ordering, and thus preserve the overall catalyst activity. A group of metal ion constituents appearing to have the desired characteristics for disrupting the oxide vacancy ordering consists of tungsten (W), niobium (Nb), tantalum (Ta), molybdenum (Mo), uranium (Ur) and thorium (Th). However, because Ur and Th are environmentally objectionable, the group is practically limited to W, Nb, Ta, and Mo. Of that group, W has been found to be particularly effective as a dopant in attaining the durability of the metal oxide as a WGS catalyst under elevated operating temperatures, though combinations of W with Nb, Ta, and/or Mo are also believed to be effective. Still further, and with respect particularly to tungsten being the dopant incorporated in the mixed-metal crystallites, the effective range of W, expressed as an atomic fraction of cations, is broadly between about 0.05 and 0.15, more specifically between about 0.07 and 0.12, and most preferably between 0.09 and 0.11.

In formulating a catalyst of a noble metal dispersion on a ceria-zirconia (and/or hafnia), nanocrystalline support material having improved durability at elevated operating temperatures, that support material is formulated to include an oxide ion vacancy-ordering inhibitor and may be made in accordance with one or the other of the following exemplary techniques.

Very generally, a ceria-zirconia, nanocrystalline catalyst support material having Ta (and/or Nb) as a dopant may be made by careful combination of three starting solutions (eg, Solutions A, B, and C). Solution A consists of (NH₄)₂Ce(NO₃)₆, ZrO(NO₃)₂.xH₂O, and de-ionized water. Solution B consists of tantalum oxalate (aqueous solution), and de-ionized water. Solution C consists of urea in de-ionized water. Solution C is heated, under constant stirring, to boiling to hydrolyze the urea and liberate the hydroxide ions. Solutions A and B are each heated to about 70° C. to 80° C. under constant stirring. Once hot, Solution B is added slowly to Solution A. If there is a mismatch between the two solutions, slow addition minimizes turbidity in the resulting mixed solution. Solution C is then quickly added to the A/B mixture and the temperature is raised to 100° C. to crystallize/precipitate the oxide from solution. The precipitate may be optionally aged or matured, or not, from 4 to 6 hours. Thereafter, the precipitated oxide material is treated generally as described in the '808 application, and includes replacing any remaining water in the solution which now contains the precipitated nano-crystalline oxide, with a water miscible, low surface-tension solvent, such as dried 2-propanol; drying the coprecipitate and solvent to remove substantially all of the solvent; and calcining the dried coprecipitate at an effective temperature, typically moderate in the range of 250° C. to 600° C. for an interval sufficient to remove adsorbed species and strengthen the structure against premature aging, typically 1-6 hours.

Very generally, a ceria-zirconia nanocrystalline catalyst support material having W (and/or Mo) as a dopant may be made by preparing and combining two solutions (Solutions A′ and B′). Solution A′ is prepared by dissolving (NH₄)₂Ce(NO₃)₆, ZrO(NO₃)₂.xH₂O, and urea in de-ionized water. Separately, Solution B′ is prepared by combining (NH₄)₂WO₄ with de-ionized water and heated to about 90° C. Solution A′ is heated to just below its boiling temperature, at which time the urea begins to hydrolyze and CO₂ gas is evolved. Solution B′ is then slowly, over the course of about a minute, added to Solution A′, for minimal turbidity and then dissolution. Once the addition is complete, the temperature of the solution is raised to 100° C. to precipitate the oxide from solution. The precipitation should occur within a minute after completing the addition of Solution B′ to Solution A′. Immediately following precipitation, the oxide material is treated thereafter in the same manner as described above with respect to the oxide containing the Ta and/or Nb dopant.

After formation of the ceria-zirconia (and/or hafnia) nanocrystalline support material, which now also contains a dopant that is an oxide ion vacancy-ordering inhibitor, the support material is prepared for the loading of catalyst, typically at least a noble metal such as Pt, possibly also in combination with Re. The process for loading the catalyst is generally as disclosed in the '808 application, and comprises the steps of 1) surface treating the support in a solution containing an acid from the group consisting of amino acids, hydroxy dicarboxylic acids, hydroxy polycarboxylic acids, and keto polycarboxylic acids; and 2) loading the catalyst metal by submerging the surface-treated support in a solution containing the catalyst metal. The solution containing the catalyst metal may be a solution of tetraamineplatinum nitrate having roughly 1 weight percent platinum, 1 weight percent ammonia hydroxide and 15 weight percent 2-propanol, and the surface-treated support is submerged therein for about 2 hours at room temperature, following which it is filtered and dried. The catalyst-loaded support is then calcined for up to 4 hours at a heating rate of about 2° C./min to a calcining temperature in the range of 250°-600° C., and more preferably in the range of 350°-500° C. If Re is to be included with the Pt as part of the catalyst loading on the support material, it may be done in accordance with the '808 application, which provides for the Pt-loaded support to be immersed in a solvent for a Re-containing material. The Re will, preferably in the presence of hydrogen gas, form a close association with the Pt.

Having described the general process for preparing the catalyst comprised of a noble metal on a cerium-containing mixed metal oxide support, which support further includes an oxide ion vacancy ordering inhibitor to enhance durability under high temperature operation, it is instructive to consider several specific formulations and processes in greater detail and to evaluate the composition, morphology, and performance typical of those formulations.

### EAMPLE 1

### UR262B—Support Synthesis

The following example demonstrates the effect of a Group VIB metal in combination with cerium and hafnium on the stability of the catalyst at high temperatures. A Ce_{0.522}Hf_{0.378}W_{0.1}O₂ catalyst support (Sample UR262) was prepared by dissolving 42.93070 g of (NH₄)₂Ce(NO₃)₆, 20.50640 g of HfO(NO₃)₂, and 286 g of urea in 4800 mL of de-ionized water. The quantity of urea was chosen to control the rate of pH change and thus the rate of crystallization of the mixed cubic from solution. The mixed aqueous solution of cerium, hafnium and urea was heated to just under boiling (about 92° C.), at which time rapid evolution of carbon dioxide gas occurred. Approximately one minute prior to full precipitation, at which time the pH would be expected to changed from acidic (e.g., 1-2) to basic (e.g., 8), a second solution comprised of 4.2593 g of (NH₄)₂WO₄ and 500 mL of de-ionized water and heated to about, or slightly above, 92° C. was added to the first solution at a rate to become thoroughly blended with the cerium, zirconium, urea solution over the course of about 1 to 2 minutes, and the complete mixture was heated rapidly to boiling.

Improper addition rate or temperatures would have resulted in a turbidity, while correct addition gave a non-turbid or nearly clear solution just before the onset of full crystallization. Immediately after the oxide crystallization/coprecipitation was observed, the mixture was removed from the heat and cooled to room temperature. The mixture was then filtered using a Buchner funnel. The resulting filter cake was washed twice with 1000 mL of de-ionized water at boiling temperature while stirring for 10 minutes, and then filtered again after each washing step. The filter cake was then washed three times with 200 mL of dried 2-propanol while inside the Buchner funnel. The filter cake was then mixed with 800 mL of dried 2-propanol and heated to reflux for 45 minutes and then filtered again before being extruded through a syringe. The extrudates were dried in a vacuum oven at 70° C. overnight. The extrudates were then calcined at 450° C. under static air conditions for 12 hours, with a heating ramp of ±10° C.

After calcination at 450° C., the surface area of the oxide with an estimated skeletal density of 8.11 g/cm³ was 146 m²/g (equivalent to 179 m²/g at the reference skeletal density of 6.6 g/cm³). The specific surface area per skeletal volume is >1200 m²/cm³, of which a pore volume is 0.21 cm³/g and the average pore diameter is 58 Å.

### EXAMPLE 2

The following example demonstrates the method of doping tantalum (Ta) or Niobium (Nb) into a ceria-zirconia nanocrystalline support material. A Ce_{0.53}Zr_{0.40}Ta_{0.07}O₂ catalyst support (Sample UR270) was prepared by the careful combination of three different starting solutions (Solutions A, B, and C). Solution A consisted of 21.8 g of (NH₄)₂Ce(NO₃)₆, 8.23 g of ZrO(NO₃)₂.xH₂O, and 2400 mL de-ionized water. Solution B consisted of 6.59 mL tantalum oxalate (aqueous solution, 1 L tantalum oxalate/176 g Ta₂O₅) and 2400 mL de-ionized water. Solution C consisted of 438 g of urea in 500 mL de-ionized water. Solution C was heated, under constant stirring, to boiling to begin to hydrolyze the urea and liberate the hydroxide ions. Solutions A and B were each heated to about 70° C. to 80° C. under constant stirring. Once hot, Solution B was added slowly to Solution A. Slow addition was necessary to minimize the turbidity of the combined Ce, Zr and/or Hf and Ta solution. Solution C (partially hydrolyzed urea, at or near boiling) was then quickly added to the A/B mixture and the temperature was raised to 100° C. to crystallize/coprecipitate the oxide from solution. After the oxide crystallization/precipitation was observed, the mixture was removed from the heat and cooled to room temperature. The mixture was then filtered using a Buchner funnel. The resulting filter cake was washed twice with 1000 mL of de-ionized water at boiling temperature, with stirring for 10 minutes, and then filtered again after each washing step. The filter cake was then washed three times with 200 mL of dried 2-propanol while inside the Buchner funnel. The filter cake was then mixed with 800 mL of dried 2-propanol and heated to reflux for 45 minutes and then filtered again before being extruded through a syringe. The extrudates were dried in a vacuum oven at 70° C. overnight, and were then calcined.

### EXAMPLE 3

The following example demonstrates the method of doping molybdenum (Mo) and Tungsten (W) into a ceria-zirconia, nanocrystalline support material. A Ce_{0.522}Zr_{0.378}W_{0.10}O₂ catalyst support (Sample UR257) was prepared by dissolving 21.5 g of (NH₄)₂Ce(NO₃)₆, 7.8 g of ZrO(NO₃)₂.xH₂O, and 144 g of urea in 4300 mL of de-ionized water (Solution A). Separately, 2.1 g of (NH₄)₂WO₄ was combined with 500 mL of de-ionized water and heated to 90° C. (Solution B). Solution A was heated to just below its boiling temperature. At this time, the urea began to hydrolyze and CO₂ gas was evolved. Solution B was then slowly added to Solution A, and a slight turbidity was observed, followed by dissolution/clearing of the solution. Once the addition was completed, the temperature of the solution was raised to 100° C. to crystallize/coprecipitate the oxide from solution. The time between the Mo and/or W addition and the precipitation was about 1 minute or less. Immediately after the oxide crystallization/precipitation was observed, the mixture was removed from the heat and cooled to room temperature. The mixture was then filtered using a Buchner funnel. The resulting filter cake was washed twice with 1000 mL of de-ionized water at boiling temperature while stirring for 10 minutes, and then filtered again after each washing step. The filter cake was then washed three times with 200 mL of dried 2-propanol while inside the Buchner funnel. The filter cake was then mixed with 800 mL of dried 2-propanol and heated to reflux for 45 minutes and then filtered again before being extruded through a syringe. The extrudates were dried in a vacuum oven at 70° C. overnight. The extrudates were then calcined at 450° C. under static air conditions for 12 hours, with a heating ramp of ±10° C.

After calcination at 450° C., the surface area of the oxide with an estimated skeletal density of 6.56 g/cm³ was 203 m²/g (equivalent to 201 m²/g at the reference skeletal density of 6.6 g/cm³). The specific surface area per skeletal volume was 1330 m²/cm³, with a pore volume of 0.26 cm³/g and an average pore diameter of 5.2 nm.

### EXAMPLE 4

### UR277—Support Synthesis

The following example demonstrates the effect of calcination environment on a tungsten-doped ceria-zirconia catalyst support. A Ce_{0.52}Zr_{0.38}W_{0.1}O₂ catalyst support was prepared according to the method described in Example 3, up to the point of oven drying at 70° C. The oven dried extrudates were then comminuted to mesh size less than 120 mesh and then spread across a 6″×4″ quartz boat to maximize the amount of exposed surface area. The powder was then calcined to 380° C. with a heating ramp of 5° C./min in CO₂, dwelled at 380° C. for 3 hours in 25% CO₂/75% O₂, ramped to 500° C. at a rate of 5° C./min, and dwelled at 500° C. overnight (approximately 10 hours), and then cooled to room temperature at 5° C./min. After calcination, the surface area of the support was 164 m²/g. The pore volume was 0.22 cm³/g and the average pore diameter was 54 Å.

### EXAMPLE 5

### UR262B—Metal Loading

The following example demonstrates the platinum and rhenium loading of a W-doped ceria-hafnia support with a composition Ce_{0.522}Hf_{0.378}W_{0.1}O₂ (UR262) which was prepared according to the method described in Example 1. The resulting material, calcined at 450° C. under static air conditions for 12 hours, was prepared for titration by adding 0.5 g of the support, comminuted to mesh size less than 120 mesh, to 100 mL ethanol. A solution of 0.54M malic acid dissolved in ethanol was used to titrate the catalyst support by adding increments of 0.1 mL until the equivalence point was sufficiently achieved (until the pH does not change significantly with each addition of acid titrant). The optimum amount was determined to be 2.0 mL/g support. Based on this finding, 3.0025 g of the catalyst support, comminuted to a 80-120 mesh size, was heated in 6.0 mL of 0.54M malic acid/ethanol solution at 50° C. for 15 minutes. The catalyst support was then washed thoroughly with ethanol, until the pH was greater than 4. After the rinse, the catalyst was dried and immersed in 7.7288 g of 0.60 wt % platinum solution by weight for 2 hours at room temperature. The platinum solution consisted of 1.6119 g of tetraammineplatinum nitrate, 1% by weight ammonia hydroxide and 15% by weight isopropanol (the balance is deionized water). The support is then filtered through a 10 μm Teflon membrane filter and vacuum-dried overnight at 70° C. The platinum-loaded catalyst was then calcined at 450° C. in static air for 4 hours, with a heating ramp of 2° C./min. ICP results indicated a final platinum loading of 1.21 wt %.

After Pt loading, 2.9496 g of the catalyst product was weighed out and placed in a 50 mL round bottom flask with 20 mL of tetrahydrofuran (THF) solution equipped with a gas inlet and outlet and bubbled with 4% H₂ (balance N₂) for 1 hour to pre-reduce the platinum already loaded on the support. Separately, 0.0357 g of Re₂(CO)₁₀ was dissolved in 20 mL of THF and then added to the 50 mL round bottom flask using a syringe needle. The mixture was allowed to stir while bubbling 4% H₂ (balance N₂) for 2 hours or until the solvent completely evaporated. The gas mixture was then switched from 4% H₂ (balance N₂) to 100% nitrogen to passivate the surface. Assuming all of the rhenium metal was delivered to the catalyst, the final Re loading was 1.21 weight percent.

### EXAMPLE 6

### UR277B—Metal Loading

The following example demonstrates the metal (platinum and rhenium) loading of a W-doped ceria-hafnia support with a composition Ce_{0.52}Hf_{0.38}W_{0.1}O₂ (UR277), which was prepared according to the method described in Example 4. The calcined material was titrated according to the method described in Example 5 for UR262B. The optimum amount of 0.54M malic acid was determined to be 2.0 mL/g support. Based on this finding, 3.0145 g of the catalyst support, comminuted to a 80-120 mesh size, was heated in 6.0 mL of 0.54M malic acid/ethanol solution at 50° C. for 15 minutes. The catalyst support was then washed thoroughly with ethanol, until the pH was greater than 4. After the rinse, the catalyst was dried and immersed in 9.1555 g of 0.98 wt % Platinum solution by weight for 2 hours at room temperature. The platinum solution consists of 0.3260 g of tetraammineplatinum nitrate, 1% by weight ammonia hydroxide and 15% by weight isopropanol (the balance is deionized water). The support was then filtered through a 10 μm Teflon membrane filter and vacuum-dried overnight at 70° C. The platinum-loaded catalyst was then calcined at 380° C. in static air for 4 hours, with a heating ramp of 2° C./min. ICP results indicated a final platinum loading of 1.56 wt %.

After Pt loading, 3.0503 g of the catalyst product was spread out across a petri dish. Separately, 0.0694 g NH₄ReO₄ was mixed with 4 mL of water. This mixture was dropwise added to the catalyst powder on the petri dish. This method of Re loading was most akin to incipient wetness. The powder was then oven dried at 70° C. and calcined at 380° C. in static air for 4 hours, with a heating ramp of 2° C./min. Assuming all the Re metal was loaded onto the catalyst, the final rhenium loading was 1.56 wt %.

### EXAMPLE 7

This example demonstrates the stability of a 1.2% Pt-1.2% Re on Ce_{0.522}Hf_{0.378}W_{0.1}O₂ catalyst according to this invention. The catalyst from example 5 has an initial surface area of 146 m²/g, a skeletal density of ˜8.11 g/cm³ and >1200 m²/cm³ of specific surface area per skeletal volume. The W was homogeneously distributed within the oxide nanocrystals. A 0.21 cm³ sample of 80-120 mesh granules of this catalyst weighing 0.44 g was tested at a space velocity of 743,000 V/V-hr under a variety of temperature and feed gas conditions for more than 720 hours. After initial careful reduction in hydrogen and 40 hours on line, the simulated reformate feed gas was set at 7.55 Mol % CO, 27.6 mol % H₂O, 5.6% mol CO₂, 28.9% mol H₂, with the remainder being N₂, and a stepwise down-ramp in temperature from ˜440° C. to ˜240° C. was initiated. Then, with the same feed gas, the temperature was increased back to 420° C. On the basis of 5 similar temperature down-ramps and 420° C. thermal hold cycles, this catalyst was projected to retain 65% of its 100 hour 420° C. activity of ˜3.3 (moles CO/mole Pt)/sec after 40,000 hours. This demonstrates the thermal stability and durability imparted by the tungsten to the nanocrystalline structure of the ceria-hafnia catalyst.

### EXAMPLE 8

A 1.56% Pt-1% Re/Ce_{0.53}Zr_{0.38}W_{0.09}O₂ catalyst was formed having an initial surface area of 164 m²/g, an average pore diameter of 5.4 nm, a pore volume of 0.22 cm³/g, and a skeletal volume of 1090 m²/cm³ based on an estimated skeletal density of 6.55 g/cm³. The composition and space velocity of the reformate feed gas, and the initial temperature down-ramp from −440° C. to ˜240° C. were as for Example 7. Then the temperature was increased back to 420° C. and held there for 100 hours, followed by a stepwise thermal down-ramp to check activity at lower temperatures and then a return to and hold at, 420° C. This catalyst sample was projected to retain 60% of its 100 hour 420° C. activity after 40,000 hours.

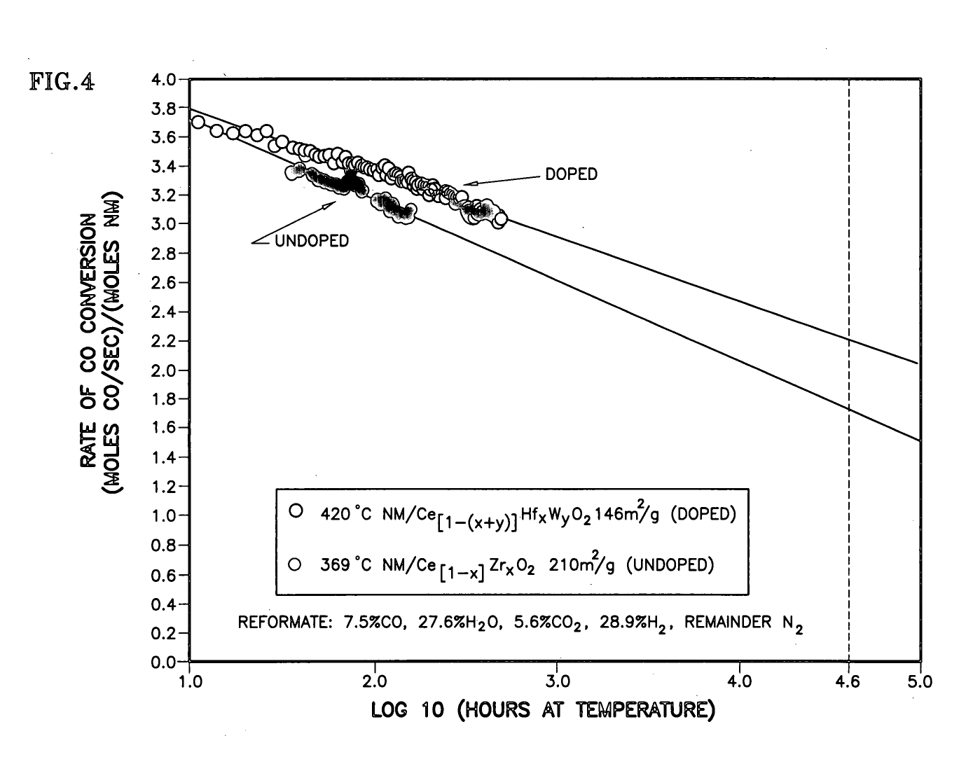

Referring now to FIG. 4, there is graphically illustrated a comparison of an “undoped” catalyst in accordance with the '808 application having a noble metal on a ceria-containing mixed metal oxide support but without a dopant as provided for in the present invention, versus a generally similar, but “doped”, catalyst in which the nanocrystalline metal oxide support additionally includes a durability-enhancing dopant, typically tungsten. The simulated reformate feed gas composition and space velocities were as for Example 7 above. Similarly, the “doped” catalyst is substantially the same as that described in Example 1, though containing Zr rather than Hf. The “undoped” catalyst was formulated as 2% Pt ˜1.6% Re on a Ce_{0.58}Zr_{0.42}O₂ support. The CO conversion activity of each catalyst was monitored for over 100 hours and extrapolated accordingly to beyond 40,000 hours. The effective maximum catalyst bed temperature for the undoped catalyst was 369° C., whereas for the doped catalyst it was ˜420° C. It is clearly seen that the thermal durability of the “doped” catalyst is considerably better than for the “undoped” catalyst. Specifically, the CO conversion activity of the “doped” catalyst is 3.4 moles/sec/mole of noble metal at 100 hours and is projected to be 2.2 moles/sec/mole of noble metal at 40,000 hours at ˜420° C., which is about 65% of the 100-hour level. Conversely, the CO conversion activity of the “undoped” catalyst is 3.2 moles/sec/mole of noble metal at 100 hours and is projected to be 1.7 moles/sec/mole of noble metal at 40,000 hours at ˜369° C., which is only about 53% of the 100-hour level and at a significantly lower temperature. The particular initial CO conversion activities of similar “doped” and “undoped” catalysts are determined principally by their respective loadings of noble metal, however the rate of decline of those CO conversion activities thereafter is determined by the thermal operating conditions and importantly, by the presence or absence of the oxide ion vacancy ordering inhibitor “dopant” of the invention.

Although the invention has been described and illustrated with respect to the exemplary embodiments thereof, it should be understood by those skilled in the art that the foregoing and various other changes, omissions and additions may be made without departing from the spirit and scope of the invention.

What is claimed is:

1. A homogeneous, nanocrystalline, mixed metal oxide of cerium and at least a first other metal constituent selected from a first group consisting of Zr and Hf and normally being susceptible to oxide ion vacancy ordering for temperatures greater than about 320° C. and further including at least a second other metal constituent selected as a dopant to inhibit oxide ion vacancy ordering, said mixed metal oxide having an average crystallite size less than 6 nm and agglomerated to form a skeletal structure with pores, average pore diameters being in the range between about 4 nm and 9 nm and normally being greater than the average crystallite size, and wherein the surface area of the skeletal structure per volume of the material of the structure is greater than about 240 m²/cm³.

2. The mixed metal oxide of claim 1 wherein the favored oxidation states under water gas shift conditions and the size and orbital structure of the cations of the second other metal constituent are selected to prevent said oxide ion vacancy ordering.

3. The mixed metal oxide of claim 1 wherein the second other metal constituent is selected as a dopant from a second group consisting of Mo, Nb, Ta, Th, U, and W.

4. The mixed metal oxide of claim 3 wherein the second other metal constituent is selected as a dopant from a second group consisting of Mo, Nb, Ta, and W.

5. The mixed metal oxide of claim 4 wherein the second other metal constituent is selected as a dopant from a second group consisting of Nb and Ta.

6. The mixed metal oxide of claim 4 wherein the second other metal constituent is selected as a dopant from a second group consisting of W and Mo.

7. The mixed metal oxide of claim 6 wherein the second other metal constituent is W.

8. The mixed metal oxide of claim 3 wherein the quantity of the second other metal selected as a dopant from the second group for preventing said oxide ion vacancy ordering is a function of at least the absolute cation fraction of Ce, the ratio of Zr and/or Hf to Ce, and the conditions including at least temperature and feed gas composition in which the mixed metal oxide is to operate.

9. The mixed metal oxide of claim 7 wherein the quantity of W, expressed as an atomic fraction of cations, is in the range of about 0.07 to about 0.12.

10. The mixed metal oxide of claim 9 wherein the quantity of W, expressed as an atomic fraction of cations, is in the range of about 0.09 to about 0.11.

11. The mixed metal oxide of claim 4 further including a noble metal dispersed thereon and supported thereby to provide a catalyst.

12. The mixed metal oxide of claim 10 further including Pt dispersed thereon and supported thereby to provide a water gas shift catalyst.

13. The mixed metal oxide of claim 12 further including Re in combination with the Pt to provide the water gas shift catalyst.

14. In a water gas shift reactor having the reformate of a carbonaceous fuel flowed in reactive contact with a catalyst for providing a water gas shift reaction, the catalyst comprising a noble metal supported on a homogeneous, nanocrystalline, mixed metal oxide, the mixed metal oxide comprising cerium and at least a first other metal constituent selected from a first group consisting of Zr and Hf and normally being susceptible to oxide ion vacancy ordering and further including at least a second other metal constituent selected to inhibit oxide ion vacancy ordering, said mixed metal oxide having an average crystallite size less than 6 nm and agglomerated to form a skeletal structure with pores, average pore diameters being in the range of about 4 nm to 9 nm and normally being greater than the average crystallite size, and wherein the surface area of the skeletal structure per volume of the material of the structure is greater than about 240 m²/cm³.

15. The water gas shift reactor of claim 14 wherein the water gas shift reaction is conducted, at least partly, at a temperature exceeding 350° C., the mixed-metal oxide supported catalyst operates to facilitate the conversion of CO to CO₂, and the activity of the mixed-metal oxide supported catalyst in converting CO to CO₂ is, at 40,000 hours of operation, at least 50% of its conversion activity at 100 hours of operation.

16. The water gas shift reactor of claim 15 wherein the water gas shift reaction is conducted, at least partly, at a temperature exceeding 400° C., and the activity of the mixed-metal oxide supported catalyst in converting CO to CO₂ is, at 40,000 hours of operation, at least 50% of its conversion activity at 100 hours of operation.

17. The water gas shift reactor of claim 15 wherein the second other metal constituent selected to prevent oxide ion vacancy ordering is selected from a second group consisting of Mo, Nb, Ta, and W.

18. The water gas shift reactor of claim 17 wherein the second other metal constituent is W.

19. The water gas shift reactor of claim 17 wherein the quantity of W, expressed as an atomic fraction of cations, is in the range of about 0.09 to about 0.11.

20. A process for the preparation of the homogeneous, nanocrystalline, mixed metal oxide as defined in claim 1, including:
a. dissolving suitable compounds of the Ce and the first other metal constituent in water to form a first solution;
b. dissolving a suitable compound of said second other metal constituent in water to form at least a second solution;
c. creating an aqueous solution containing urea, either as a separate third solution or in combination with the Ce-containing first solution;
d. heating each of the respective first, second, and if present, third solutions to respective appropriate temperatures ranging from about 70° C. to near boiling;
e. combining the first, second, and if present, third solutions in a predetermined sequence and manner;
f. heating the solution combined in step e nominally to boiling and coprecipitating homogeneously a crystalline oxide of the Ce, the first other metal constituent, and the second other metal constituent as a nanocrystalline coprecipitate;
g. replacing water existing in the crystalline coprecipitate with a water miscible, low surface-tension solvent that displaces water;
h. drying the crystalline coprecipitate to remove substantially all of any remaining water and the solvent; and
i. calcining the dried crystalline coprecipitate at a moderate temperature below about 600° C. for an interval sufficient to remove adsorbed impurities.

21. A process for the preparation of the homogeneous, nanocrystalline, tungsten and/or molydenbum-doped ceria-containing mixed metal oxide as defined in claim 6, including:
a. dissolving suitable compounds of Ce, of Zr and/or Hf, and urea in water to form a first metal salt-urea solution;
b. dissolving one or more suitable compounds of W and/or Mo in water to form a dopant metal solution.
c. heating the first metal salt-urea solution to near but just under boiling;
d. heating the dopant metal solution to near but just under boiling;
e. about one minute prior to crystallization of the mixed metal oxide, adding the dopant metal solution to the metal salt-urea solution over the course of about a minute to minimize turbidity;
f. heating the combined first metal salt-urea solution and the dopant metal solution to boiling until full crystallization and coprecipitation of the doped ceria-containing mixed metal oxide results;
g. recovering the crystallized doped ceria-containing mixed metal oxide as a solid;
h. washing the crystallized doped ceria-containing mixed metal oxide with water;
i. replacing the water existing in the crystallized doped ceria-containing mixed metal oxide with a water miscible, low surface-tension solvent that displaces water;
j. drying the crystallized doped ceria-containing mixed metal oxide to remove substantially all of any remaining water and solvent; and
k. calcining the dried coprecipitate at a moderate temperature below about 600° C. for an interval sufficient to remove adsorbed impurities and stabilize the structure.

22. A process for the preparation of the homogeneous, nanocrystalline, tantalum and/or niobium-doped ceria-containing mixed metal oxide as defined in claim 5, including:
a. dissolving suitable compounds of Ce, and of Zr and/or Hf, in water to form a first metal salt solution;
b. dissolving one or more suitable compounds of Ta and/or Nb in water to form a dopant metal solution;
c. dissolving urea in water to make an aqueous urea solution;
d. heating each of the first metal salt solution and the dopant metal solution to respective elevated temperatures in the range of about 70° C. to 80° C.;
e. heating the aqueous urea solution nominally to boiling;
f. slowly adding the dopant metal solution to the first metal salt solution at an elevated temperature less than boiling but at least as great as the highest temperature in step d, to minimize turbidity;
g. quickly adding the boiling aqueous urea solution to the combined dopant metal solution and the first metal salt solution substantially at boiling such that full crystallization and coprecipitation of the doped ceria-containing mixed metal oxide results;
h. recovering the crystallized doped ceria containing mixed metal oxide as a solid;
i. washing the crystallized doped ceria-containing mixed metal oxide with water;
j. replacing the water existing in the crystallized doped ceria-containing mixed metal oxide with a water miscible, low surface-tension solvent that displaces water;
k. drying the crystallized doped ceria-containing mixed metal oxide to remove substantially all of any remaining water and solvent; and
l. calcining the dried coprecipitate at a moderate temperature below about 600° C. for an interval sufficient to remove adsorbed impurities and stabilize the structure.
